(19) United States
(12) Patent Application Publication
(10) Pub. No.: US 2010/0306171 A1
(43) Pub. Date: Dec. 2, 2010

(54) Timeline Experience for Restore User Interface

(75) Inventors: Kynan D. Antos, Seattle, WA (US); Bryce S. Boyd, Redmond, WA (US); Michael Sliger, Sammamish, WA (US)

Correspondence Address: MICROSOFT CORPORATION, ONE MICROSOFT WAY, REDMOND, WA, 98052, US

(73) Assignee: Microsoft Corporation, Redmond, WA (US)

(21) Appl. No.: 12/476,287

(22) Filed: Jun. 2, 2009

(51) Int. Cl. G06F 12/00; G06F 12/16; G06F 3/048

(52) U.S. Cl. 707/638; 715/781; 711/E12.001; 711/E12.103; 707/822; 707/640

(57) ABSTRACT

A backup restoration system may present two or more versions of a file in a graphical user interface. A user may examine the versions to identify a desired version, and the desired version may be restored. The system may identify changed versions of the file from many stored instances of the file in the backup system, and may present the changed versions within the user interface. In some embodiments, a timeline may be presented that displays when the file was changed. Some embodiments may also highlight the changes in the display. Some embodiments may present the versions of a file in a horizontal format, where two or more versions may be viewed side by side.

### BACKGROUND

Computer backup systems typically store versions of files at various times. Some backup systems may store files once a day, typically at night. Other backup systems may store files every hour of the day, for example. In many cases, the files may be stored according to a file system through which the files may be accessed. When backing up a typical file system, the backup instance may include a file system with a hierarchy of directories or folders in which files may be organized.

Each time a backup operation occurs, a new version of a file may be stored in a backup database. In many cases, a backup database may include many versions of a file system, with some instances having many dozens or even hundreds of versions of a file or file system.

A backup system may be used to recover or restore one or more files, portions of a file system, or an entire file system from a previous version. In one use scenario, a user may accidentally delete a file or make a change to the file that is later regretted. The user may wish to restore the file to a previous version, and may identify the file in the backup system, then cause an older version of the file to be restored.

### SUMMARY

A backup restoration system may present two or more versions of a file in a graphical user interface. A user may examine the versions to identify a desired version, and the desired version may be restored. The system may identify changed versions of the file from many stored instances of the file in the backup system, and may present the changed versions within the user interface. In some embodiments, a timeline may be presented that displays when the file was changed. Some embodiments may also highlight the changes in the display. Some embodiments may present the versions of a file in a horizontal format, where two or more versions may be viewed side by side or with some other orientation.

This Summary is provided to introduce a selection of concepts in a simplified form that are further described below in the Detailed Description. This Summary is not intended to identify key features or essential features of the claimed subject matter, nor is it intended to be used to limit the scope of the claimed subject matter.

### BRIEF DESCRIPTION OF THE DRAWINGS

In the drawings,

FIG. 1 is a diagram illustration of an embodiment showing a system for backup and recovery.

FIG. 2 is a flowchart illustration of an embodiment showing a simplified backup system operation.

FIG. 3 is a flowchart illustration of an embodiment showing a method for presenting backup versions and restoration.

FIG. 4 is a flowchart illustration of an embodiment showing a method for analyzing backup versions of a file.

FIG. 5 is a diagram illustration of a first embodiment showing a graphical user interface.

FIG. 6 is a diagram illustration of a second embodiment showing a graphical user interface.

FIG. 7 is a diagram illustration of a third embodiment showing a graphical user interface.

### DETAILED DESCRIPTION

A backup restoration system may search for versions of a particular file across multiple backup instances, and present the versions for selection. A user may select a particular version and that version may be restored. In many embodiments, only those versions that are changed between backup instances may be presented.

A backup system may store versions of a file system in a backup storage system. Typically, a backup may be performed periodically, such as every week, day, hour, or some other interval. Each backup instance may be stored so that a file or file system may be restored to the same state as when the file or file system was backed up.

The backup restoration system may search for a single file or portion of a file system across multiple backup instances to find versions of the file or file system. In some embodiments, each backup instance may be examined to determine if a file having the same name or other identifier is present, and if so, the version of the file may be added to a set of versions for the file. Other embodiments may have different mechanisms for searching across backup instances.

In many cases, a user may not know exactly which version of a file that may be desired. When using the backup restoration system, the user may know certain metadata, such as the file name, document type, tags, or other metadata, or the user may know content keywords, snippets, or other portions of the content. However, the user may not know the precise date that the file was backed up. The backup restoration system may allow a user to search for a file using metadata, content, or other identifiers to find the versions of the file from a backup storage, and may present the versions for the user to select.

In many embodiments, a graphical user interface may be used to display and browse the versions. The display may show two or more graphical representations of versions side by side so that a user may be able to compare the versions visually. Some embodiments may analyze the various versions to identify and highlight changes between versions to aid the user's comparison.

The graphical user interface may include a timeline device that may illustrate when a file was changed. The timeline may have an indicator showing each version of a file. In many cases, a file may be updated in one backup instance, but may be unchanged for several other instances until another change is made. Some embodiments may remove the unchanged instances from the set of versions to display and may show a subset of the versions where a change was made.

Throughout this specification, like reference numbers signify the same elements throughout the description of the figures.

When elements are referred to as being “connected” or “coupled,” the elements can be directly connected or coupled together or one or more intervening elements may also be present. In contrast, when elements are referred to as being “directly connected” or “directly coupled,” there are no intervening elements present.

The subject matter may be embodied as devices, systems, methods, and/or computer program products. Accordingly, some or all of the subject matter may be embodied in hardware and/or in software (including firmware, resident software, micro-code, state machines, gate arrays, etc.) Furthermore, the subject matter may take the form of a computer program product on a computer-usable or computer-readable storage medium having computer-usable or computer-readable program code embodied in the medium for use by or in connection with an instruction execution system. In the context of this document, a computer-usable or computer-readable medium may be any medium that can contain, store, communicate, propagate, or transport the program for use by or in connection with the instruction execution system, apparatus, or device.

The computer-usable or computer-readable medium may be, for example but not limited to, an electronic, magnetic, optical, electromagnetic, infrared, or semiconductor system, apparatus, device, or propagation medium. By way of example, and not limitation, computer readable media may comprise computer storage media and communication media.

Computer storage media includes volatile and nonvolatile, removable and non-removable media implemented in any method or technology for storage of information such as computer readable instructions, data structures, program modules or other data. Computer storage media includes, but is not limited to, RAM, ROM, EEPROM, flash memory or other memory technology, CD-ROM, digital versatile disks (DVD) or other optical storage, magnetic cassettes, magnetic tape, magnetic disk storage or other magnetic storage devices, or any other medium which can be used to store the desired information and which can accessed by an instruction execution system. Note that the computer-usable or computer-readable medium could be paper or another suitable medium upon which the program is printed, as the program can be electronically captured, via, for instance, optical scanning of the paper or other medium, then compiled, interpreted, of otherwise processed in a suitable manner, if necessary, and then stored in a computer memory.

When the subject matter is embodied in the general context of computer-executable instructions, the embodiment may comprise program modules, executed by one or more systems, computers, or other devices. Generally, program modules include routines, programs, objects, components, data structures, etc. that perform particular tasks or implement particular abstract data types. Typically, the functionality of the program modules may be combined or distributed as desired in various embodiments.

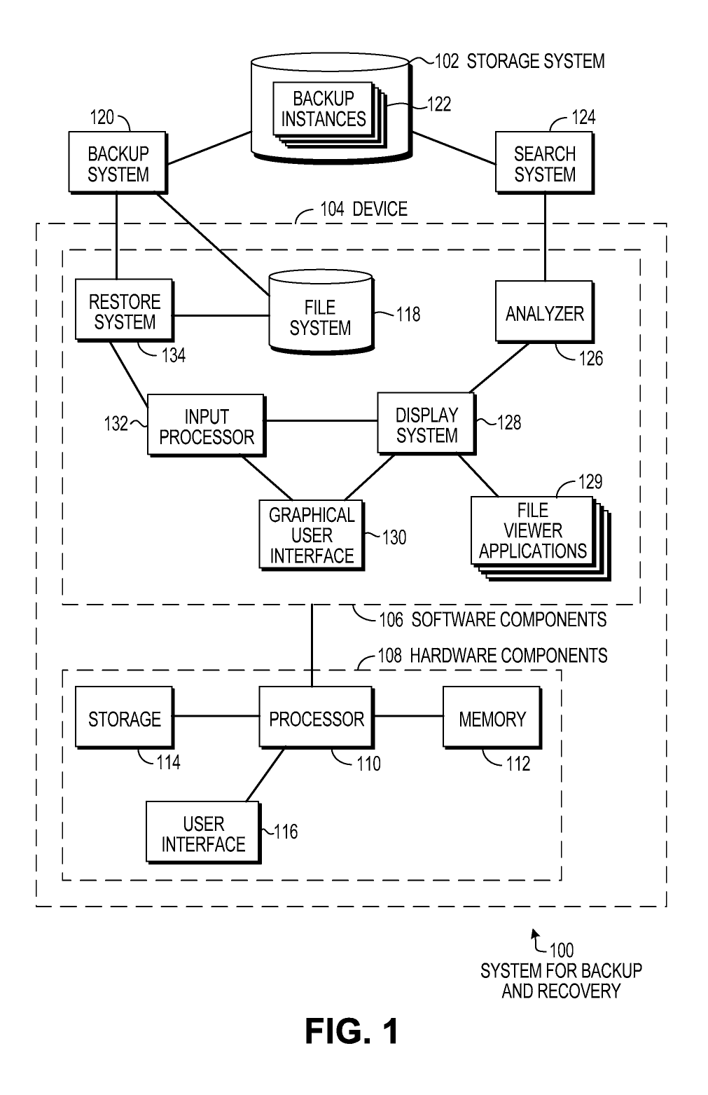

FIG. 1 is a diagram of an embodiment 100 showing a system for backup and recovery of data. Embodiment 100 is an example of a system that may collect backup instances and may allow a user to search those instances for versions of a file, then select a version to recover.

The diagram of FIG. 1 illustrates functional components of a system. In some cases, the component may be a hardware component, a software component, or a combination of hardware and software. Some of the components may be application level software, while other components may be operating system level components. In some cases, the connection of one component to another may be a close connection where two or more components are operating on a single hardware platform. In other cases, the connections may be made over network connections spanning long distances. Each embodiment may use different hardware, software, and interconnection architectures to achieve the functions described.

Embodiment 100 is a simplified example of the components that may be present in a backup and recovery system. The system may create backup instances that may be capable of recreating or recovering a file, portions of a file system, or an entire file system. In order to find a desired version of a file, the backup instances may be searched to find different versions of the file, where each version may be stored in a different backup instance.

When a user desires to restore a file, the user may know some information about the file, but may not know the precise date that the file may have been backed up. In many cases, the information may be a file name, directory location, tags, keywords, or other metadata that may be used to search and locate a file from multiple backup instances. The results of such a search may be a set of versions of a file.

A search of the backup database may produce multiple versions of a file. The versions may be presented on a user interface for browsing and selection. When a user selects a desired version, that version may be recovered from the backup storage and placed in a location where the file may be used.

The user interface may be a graphical user interface on which one or more versions of the file may be displayed. In many cases, two or more versions may be placed next to each other so that a user may be able to examine the two versions for differences between the versions.

In one such embodiment, two or more versions may be placed side by side using graphical representations of the versions. In the embodiment, a user may be able to scroll through several different versions of the file to select a desired version. Other embodiments may present multiple versions in different manners, such as a vertical arrangement or using some other presentation. In some cases, graphical representations may be presented partially overlapping, with some representations being opaque or partially transparent. In many cases, the versions may be presented so that a user may inspect the contents of the file to identify changes between the versions.

A graphical representation may be a page view of a text document, a reduced size image of a graphical image, or some other representation that may be appropriate for the type of file. In some cases, a graphical representation may include an ability to examine a version using scrolling, panning, zooming, or other navigation mechanisms. In many embodiments, a viewer application for a specific file type may be used to examine a file.

In some embodiments, an analysis may be performed to reduce the number of versions of a file to a subset of versions. The subset may include those versions that are different from other versions.

In an example of a lifecycle of a file, a user may create the file and store the file for a period of time, such as several days or weeks. The user may edit the file, make some changes, and store the file again for a second period of time. If a backup system performs a backup operation each day, the backup system may have many dozens of versions of the file within the backup database, many of which may be identical. By analyzing the versions, a subset of the changed versions may be reduced to only those versions that are different. In the example, the versions may include the initial version when the file was created, and additional versions each time the file was edited and changed.

A subset of versions that may be displayed may be very useful for a user, especially when a backup system may have many backup instances. In such an embodiment, the user may only be presented with the different versions of the file without having to browse through many dozens or even hundreds of versions that are identical.

In some embodiments, the changes between versions may be highlighted or emphasized for the user. For example, changes in a text document may be illustrated by showing removed text with a strikethrough and added text with underlining. Other examples may include using transparent color overlays in a section of an image that was changed or highlighting changed portions of a spreadsheet or other document.

When the subsets of versions are identified, a timeline user interface mechanism may be created. The timeline may illustrate a continuum of time on which each changed version may be indicated or highlighted. The timeline may graphically illustrate when changes were made to a file and may be useful when browsing through changed versions of a file.

In some embodiments, the timeline user interface may be an interactive component of a graphical user interface, allowing a user to select a version for display or recovery directly from the timeline user interface.

Backup systems may store copies of data from any data source. In a typical embodiment, a computer device may store data in the form of files that are stored in a file system, such as a hierarchical file system that may have a hierarchy of directories and subdirectories. In some cases, data may be stored in other types of databases or file systems.

Throughout this specification and claims, references are made to files as the item for which a search may be performed. In a typical embodiment, a file may be a word processing document, image file, or other file type. In some cases, the file may be a directory or subdirectory, which may include references to other files. In such a case, a backup system may be searched for versions of a subdirectory, and versions of the subdirectory may be presented on a graphical user interface. A user may select the subdirectory to restore, and the directory and its contents may be recovered. Throughout this specification and claims, any reference to a ‘file’ when searching, analyzing, displaying, selecting, or recovering may also apply to a directory, subdirectory, or other portion of a file system.

Embodiment 100 illustrates a system that has a storage system 102 that is used to store backup information for a device 104. Embodiment 100 is a generic representation of a device 104 that may have software components 106 and hardware components 108. A typical embodiment of a device 104 may be a personal computer or server computer that uses a conventional operating system. Such operating systems may store files that are used by various applications, and may arrange the files in a hierarchical directory structure.

The device 104 may be any type of computing device that has data that may be backed up. In addition to the personal computer example above, other examples may include a handheld cellular telephone on which may be stored application data, contact data, or other information. Such data may be stored in files using a directory-type file system or in other database formats. Another example may include a data collection instrument that may store collected data in data files. Still another example may be a server computer that provides services to other devices.

The hardware components 108 may include a processor 110 that may execute the various software components 106, as well as random access memory 112, some sort of mass storage system 114, and a user interface 116.

The processor 110 may be a general purpose processor that uses the random access memory 112 to store commands that are to be executed as well as other memory objects. In a typical embodiment, a high speed bus may be used between the processor 110 and the memory 112. In some embodiments, the memory 112 may be volatile memory that may be erased when power is turned off of the device 104.

The storage system 114 may be a non-volatile memory system, such as a disk drive or other mass storage system. In many embodiments, a file system may be created and managed on the storage system 114. Applications running on the processor 110 may create files, store information in the files, and modify the files.

The device 104 may have a user interface 116. In many embodiments, the user interface 116 may include a graphical display device as well as some type of user input device. A graphical display device may be a monitor, projector, or other device. The user input device may be a pointing device such as a mouse, touchscreen, stylus, trackball, or other pointer. In some cases, the user input device may include a keyboard or other button devices.

The software components 106 may include a file system 118, which may be stored on the storage system 114. The file system 118 may be used to organize, categorize, or otherwise manage the data on the storage device 114.

A backup system 120 may perform backup operations on the file system 118 and may create multiple backup instances 122. The backup system 120 may perform a backup operation on a scheduled basis, such as every hour, every day, or some other predefined schedule. In some cases, the backup system 120 may perform backup operations on demand, such as whenever a user selects.

Different types of backup systems may create backup instances in different manners. Some backup systems may periodically create a full backup and subsequent incremental backups. A full backup may be a complete copy of the file system 118, and the incremental backups may be portions of the file system 118 that have been changed from the last backup. In such a system, a file system or portion of a file system may be recreated by first restoring the full backup, then applying the incremental backups to recreate the desired version.

Other backup systems may not use a full backup and incremental backup approach. Some backup systems may perform a full backup at each operation, for example. Such a system may consume larger amounts of storage space than an incremental backup system, as each backup may store all of the contents of the file system 118, but such a system may be less complex.

Another type of backup system may backup blocks of data, and may create a table that represents the blocks of data in a particular backup instance 122. The table may be used to recreate any backup instance by retrieving the blocks of data stored in the storage system 102. Such a system may be used to create large number of backup instances without consuming large amounts of storage space.

Any type of backup system may be used in the embodiment 100. Some embodiments may be optimized for efficient use of storage space, while other embodiments may be optimized for efficient searching, retrieval, or other functions. One example of a generic operation of backup system may be found in embodiment 200 presented later in this specification.

The storage system 102 that contains the backup instances 122 may be any type of suitable storage mechanism. In some cases, tape storage, optical storage, disk storage, or other technologies may be used to store backup instances 122. In some embodiments, the storage system 102 may be directly attached to the device 104 through an interface port, such as a Universal Serial Bus connection or other connection. In other embodiments, the storage system 102 may be accessed through a local area network or a wide area network, such as the Internet.

The search system 124 may search the backup instances 122 to find versions of a file, directory, or other portions of a file system. The search system 124 may be given various criteria on which to search, and may return multiple versions of a file, directory, or other portions of a file system, each of which may have been stored in a different backup instance 122.

For example, a file located in a certain directory and having a file name ‘tpsreports.doc’ may be searched by the search system 124. The search system may examine each of the backup instances 122 and return each version of the ‘tpsreports.doc’ file that is stored in the storage system 102. In embodiments where many dozens or even hundreds of backup instances may be kept, the search system 124 may find versions of the file in each of the backup instances.

The search system 124 may generate a set of versions for a file that includes one version for each of the backup instances 122 in which the file is found. In many cases, the backup instances 122 may contain many identical versions of a document. For example, a file that is stored in a file system but is not changed may have an identical version for each backup instance. The analyzer 126 may remove the identical versions of the file to create a subset of versions that are non-identical or different in some manner.

A display system 128 may present the results of a search on a graphical user interface 1 30. Different embodiments may have different techniques and different mechanisms for displaying results of a search and receiving user input. The user input may be used to navigate or browse through the search results, and may be used to select items to recover.

In many embodiments, a display system 128 may present the subset of search results, where the subset includes the changed versions of a file. The subset may allow a user to view only those versions that are different from other versions. In some embodiments, a timeline graphical element may be displayed that shows a time segment with identifiers for several versions of the file. The timeline element may, in some cases, be an interactive element where a user may select a version from the timeline, or may scroll or browse the versions by interacting with the timeline.

Some embodiments may use file viewer applications 129 to present an interactive view of a particular file type. In such embodiments, each supported file type may have a file viewer application. For example, file viewer applications 129 may be present for word processing documents, spreadsheets, presentation documents, image editing applications, or other document formats. In some cases, a file viewer application may allow a user to scroll through a file, zoom into or out of the file, or otherwise navigate through the file. In cases where a specific file type does not have a file viewer application 129, a generic file presentation mechanism may be used to display some contents of a file.

In some cases, the display system 128 may display various metadata about a file. Some such embodiments may present the metadata without presenting the contents of a file, or may present metadata in addition to the contents of a file. The metadata may include information about the file within the backup instances 122, such as a directory path, date of backup, file size, file type, or other information. In some embodiments, the metadata may include tags, keywords, or other parameters that may be used by a search system or by an application that created the file or may use the file.

The display system 128 may generate a graphical user interface 130. The graphical user interface 130 may be displayed on the hardware user interface 116. The graphical user interface 130 may include a graphical representation of a version of a file, a timeline mechanism, and various input mechanisms. In many cases, other data may also be displayed. Examples of a graphical user interface are presented later in this specification.

An input processor 132 may work in conjunction with the display system 128 to provide an interactive user experience. The input processor 132 may receive user input, such as button selections, text input, cursor movements and gestures, and other input to update the graphical user interface 130 through the display system 128. In some cases, the input processor 132 may cause a restore system 134 to retrieve a version of a file and restore the file to the file system 118.

Embodiment 100 is an example of a system that may be used to search a backup database to find versions of a file, generate and present a graphical user interface showing the search results, and select and restore a version of the file to a file system. The components and arrangement of components of embodiment 100 are merely one example of a system that may perform the functions described. Other embodiments may have different architectures that may perform a subset or superset of the functions described for embodiment 100.

In embodiment 100, the functions of a backup system 120, storage system 102, and search system 124 are shown as being outside the bounds of the device 104. In some cases, the backup system 120, storage system 102, and search system 124 may be performed by a remote device, such as a server on a local area network or by a remote service available over an Internet or other wide area network connection.

In some embodiments, the backup system 120, storage system 102, and/or the search system 124 may be incorporated into the device 104.

Some embodiments may have an architecture in which all of the software components 106, with the exception of the file system 118, may be performed by a remote service, such as a server connected to a local area network or by a remote service available over a wide area network. In such an embodiment, the remote service may generate a user interface that may be defined, for example, in HTTP or other format that may be displayed on the device 104 using a web browser or other application.

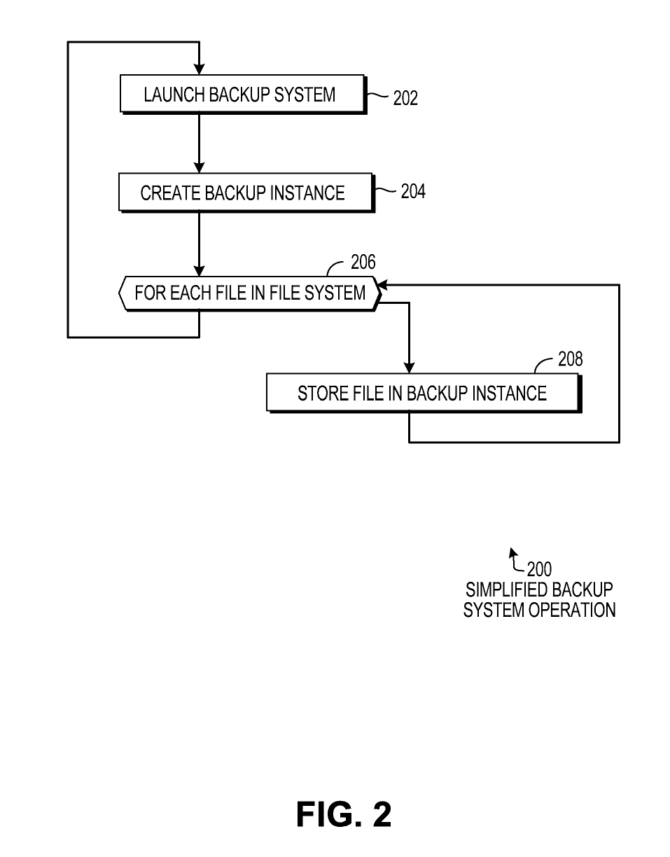

FIG. 2 is a flowchart illustration of an embodiment 200 showing a simplified method for operation of a backup system. Embodiment 200 is a simplified example of a method that may be performed by a backup system 120 to create a backup instance 122 from the file system 118, as described in embodiment 100.

Other embodiments may use different sequencing, additional or fewer steps, and different nomenclature or terminology to accomplish similar functions. In some embodiments, various operations or set of operations may be performed in parallel with other operations, either in a synchronous or asynchronous manner. The steps selected here were chosen to illustrate some principles of operations in a simplified form.

Embodiment 200 is a generic example of a backup system that may periodically store a version of a file system into a backup instance. After launching a backup system in block 202, a backup instance may be created in block 204. For each file in the file system in block 206, a copy of the file may be stored in the backup instance in block 208.

In many embodiments, a backup system may operate on a regularly scheduled basis. In a business or other enterprise, a backup may be performed on a nightly or weekly basis, for example. On a personal computer, a backup may be performed every few minutes in some cases.

Some embodiments may perform a backup operation when initiated by a user or through some other event. For example, a user may initiate a backup at any time, such as before the user updates a system or performs maintenance on the system. Some backup operations may be triggered by an event such as modifying a certain number of files, for example.

Some embodiments may be able to perform a backup operation based on a snapshot of a file system at an instance of time. In such a system, a backup system may store files as those files existed at the point in time the backup was started. Such systems may track changes to files during the backup operation so that a user may continue to modify and interact with the files while a backup operation is underway.

Many different mechanisms may be used to perform backup operations and to create multiple versions of a file or file system over time. Each backup system may have different mechanisms for retrieving files and creating backup instances.

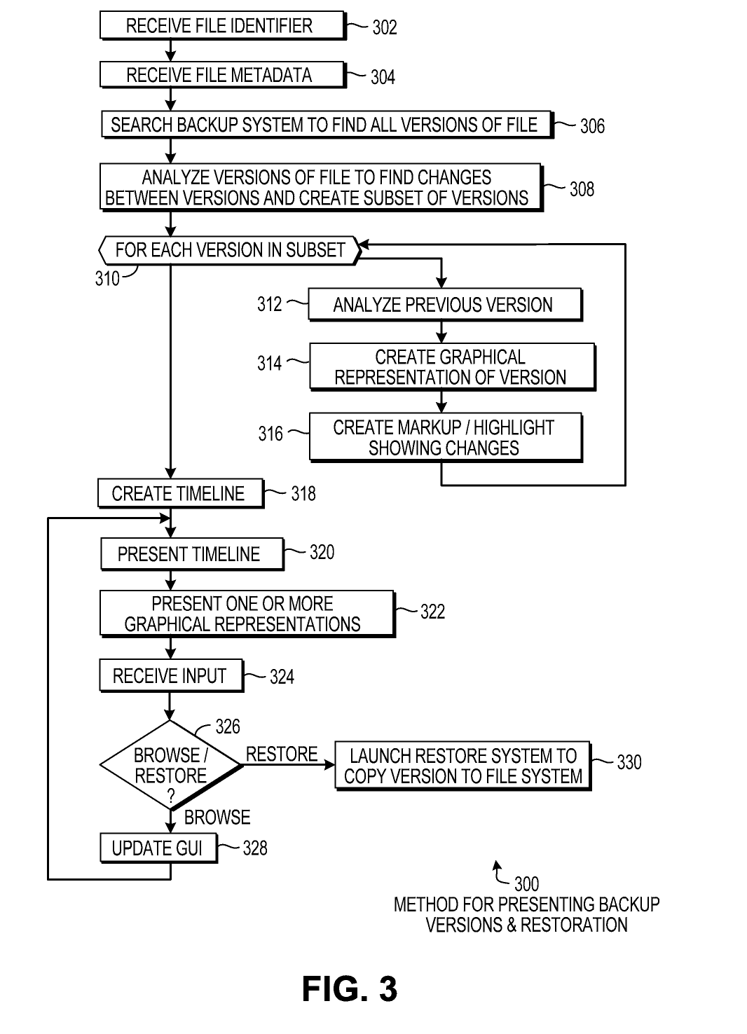

FIG. 3 is a flowchart illustration of an embodiment 300 showing a method for presenting backup versions and restoring one of the versions. Embodiment 300 is a simplified operation of several of the components of embodiment 100.

Other embodiments may use different sequencing, additional or fewer steps, and different nomenclature or terminology to accomplish similar functions. In some embodiments, various operations or set of operations may be performed in parallel with other operations, either in a synchronous or asynchronous manner. The steps selected here were chosen to illustrate some principles of operations in a simplified form.

Embodiment 300 illustrates a simplified method for performing a search of a backup system, presenting the search results in a graphical user interface, and restoring a selected version. Embodiment 300 searches a backup system using file identifiers and returns multiple versions of a file. The versions of the file may be browsed and selected.

A file identifier may be received in block 302, as well as file metadata in block 304. The file identifier and file metadata may be used to search for versions of the file in block 306.

The file identifier and file metadata may be any search parameters that may be used to search for a file in a backup database. In many cases, a file name and a file directory may serve as a file identifier. In a typical use scenario, a user may know the directory in which a file of interest is located, as well as the file name. A search may be performed to identify each version of the file meeting the criteria. In some cases, a file directory may not be known and the file name may be used alone to perform a search.

In some embodiments, a search may be performed using metadata in lieu of or in addition to a file identifier. When metadata is used in lieu of a file identifier, versions of a file meeting the criteria may be returned from the search process. When metadata is used in addition to a file identifier, the search may further restrict the search results. A use scenario may be to search for a file named “tpsreports.doc” where the file size is less than 250 KB. In such a scenario, all of the versions of “tpsreports.doc” may be further limited to only those versions where the file size is less than 250 KB.

Other examples of metadata may include a range of dates to search, a file type, a range of file sizes, keywords, tags, or other information. Some embodiments may use additional types of metadata for searching. In some cases, some metadata parameters may be available for certain types of files but not available for other types of files.

In some embodiments, a file search may be performed using portions of the contents of a file. For example, a word processing document may be searched using a phrase or paragraph that may be included as content of a file. In some such embodiments, a backup system may include indexes or other features that may allow faster searching of the backup database.

In one use scenario, a search may be performed looking for versions of a file that contains specific text. For example, a search may be performed for versions of “tpsreports.doc” that include the text “new stapler”. Those versions may be presented in a user interface for potential recovery.

The search results in block 306 may return all instances of a file that are stored in a backup database. In some cases, many of the stored instances may be identical, which can happen when multiple backup operations occur when the file goes unchanged. In embodiments where many dozens or even hundreds of backup instances may be stored in a backup system, this may return many dozens or even hundreds of versions of a file that are identical.

In block 308, the versions of a file may be analyzed to identify a subset of versions that include only the changed versions of a file. Embodiment 400 presented later in this application may include one method for determining the changed versions.

The subset of versions produced in block 308 may include only those versions where a change occurred between backup operations. When many dozens or even hundreds of identical versions are present, removing the identical versions may allow a user to quickly browse through only the changed versions rather than hundreds of identical versions.

In some embodiments, the analysis of block 308 may identify a different version on a bit-wise comparison of two versions of a file. In such a case, even the slightest change to a file between versions may include both versions in the subset. In some such embodiments, a large number of changed versions may be identified even when only slight changes are detected.

In other embodiments, a threshold may be used to determine when a version is different enough from a previous version to add the changed version to the subset of versions. For example, an analysis routine may analyze the contents of a file, and when the contents are the same, the file is considered identical even if the metadata for the version changes. In another example, analysis routine may identify a changed version only when a change affecting more than 1%, 10% or some other amount of the content of a file is realized. In some embodiments, a user may be able to set a threshold for identifying the amount of change to a file that may include or exclude the file from the subset of versions.

In preparation for a graphical representation of the versions of a file, each version in the subset of versions may be analyzed in block 310. The analysis in block 310 may create highlights or markups to show changes between versions so that a user may quickly browse the versions and identify variations between the versions.

For each version in block 310, the previous version maybe analyzed in block 312 to identify what portions of the file are different. In block 314, a graphical representation of the version may be created, and in block 316, a markup or highlight showing the changes may be created.

The analysis of block 310 may create visual highlights of the changes between versions. Many different techniques may be used to highlight changes between versions. In a text document, such as a word processing document, a highlight or markup operation may show deleted text with strikethrough or bracketing and additional text with underlining. In another example of a text document, deleted text may not be shown at all or may be shown with red highlighting, while added text may be shown with yellow highlighting.

In many embodiments, a partially transparent highlighting may be used to show changed elements. For example, a graphic image such as a photograph may show edits to the photograph using a highlighted transparent color overlay over the edited portions of the image.

In order to determine where the highlighting or markup is to be shown, the comparison between two versions may be performed in block 312. In some embodiments, different types of comparison algorithms may be performed for certain types of files. For example, different plugins or other support applications may be used to analyze word processing documents, spreadsheets, image files, audio files, video files, or other types of files. In some embodiments, the plugins or support applications may be installed into a backup system, and may additionally perform the functions of the file viewer applications 129 as described in embodiment 100.

Using the subset of versions identified in block 308, a timeline may be created in block 318. The timeline may be a graphical representation of time showing the changed versions of a file with respect to time. Several examples of a graphical timeline may be found in embodiments 500, 600, and 700 presented later in this specification.

The timeline may be an interactive mechanism in a graphical user interface that may allow the user to browse different versions of a file and navigate through the various versions. In many cases, the timeline may act as a scroll bar allowing the user to scroll backwards and forwards through time, with a current version of the file being presented graphically within the user interface.

The timeline may be presented on a user interface in block 320, along with one or more graphical representations of the versions of the file in block 322. A user may provide input in block 326. If the input is a command that relates to browsing the versions in block 326, the graphical user interface may be updated in block 328 and the process may return to block 320.

The browsing action of the graphical user interface may enable a user to scroll through or navigate between different versions of a file while viewing the different versions of a file. In embodiments where the highlighting or markup operations are used, the use may quickly recognize the changes made to a file, which may assist in determining a desired version.

Once a user has selected a desired version for recovery or restore in block 326, a restore system may be launched to copy the desired version from the backup system to a file system. After the restore operation has completed, the user may be able to view, edit, and manipulate the file.

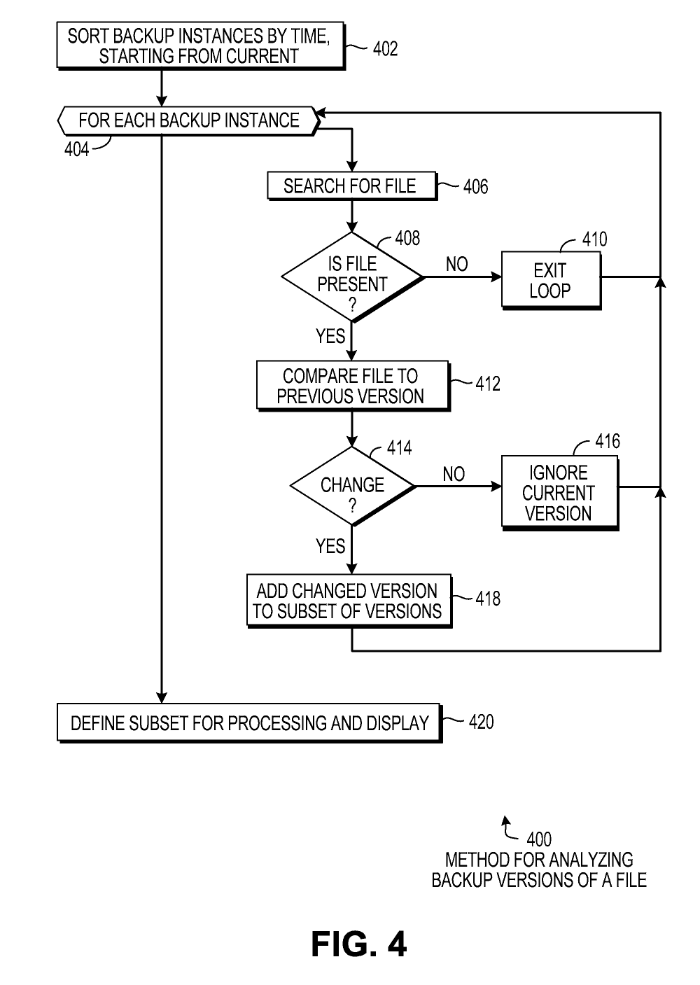

FIG. 4 is a flowchart illustration of an embodiment 400 showing a method for analyzing backup versions of a file. Embodiment 400 is merely one method of analysis that may be used for the searching of block 306 and analysis of block 308 of embodiment 300. Embodiment 400 is an example of a process that may be performed by the search system 124 and the analyzer 126 of embodiment 100.

Other embodiments may use different sequencing, additional or fewer steps, and different nomenclature or terminology to accomplish similar functions. In some embodiments, various operations or set of operations may be performed in parallel with other operations, either in a synchronous or asynchronous manner. The steps selected here were chosen to illustrate some principles of operations in a simplified form.

Embodiment 400 is a method by which a full set of search results may be reduced to those versions that show changes to a file. The search results from a backup system may include versions of a file from each backup instance. In many cases, there may be many versions that are identical. The process of embodiment 400 creates a subset of the versions of a file that includes different versions of the file. The process of embodiment 400 effectively removes duplicate versions from the set of search results, which may make browsing and selecting a desired version easier and simpler.

Embodiment 400 performs both the searching and analysis functions in a single routine. Other embodiments may separate the two functions as described in blocks 306 and 308 of embodiment 300 and the search system 124 and analyzer 126 of embodiment 100.

Embodiment 400 is an example of a search and analysis method that may be performed with a backup system that creates individual instances for each backup operation. Some backup systems may not store individual instances for each backup and may, for example, store a periodic full backup instance with several incremental instances. Other backup systems may have different storage architectures or backup mechanisms. As such, other backup systems may use a different method for searching and analyzing versions of a file.

In block 402, the backup instances stored in a backup system may be sorted by time, starting from the most current file.

Each backup instance may be evaluated in block 404. In block 406, a search may be made for the file within the backup instance. In many cases, the search may use file indicators, such as a file name and directory, as well as various metadata.

In some embodiments, a search may include searching for recently deleted files. Recently deleted files may be those files which have been deleted since the last backup operation, or deleted within some predefined timeframe. In many cases, the recently deleted files may be those files that are much more likely to be restored from a backup system. Such embodiments may maintain a list of files that have been deleted, or may compare the file structure of a previous backup to determine which files have been deleted since the last backup operation.

If the file is not present in block 408, the loop may be exited in block 410. An exit at this point may be for conditions where older versions of a file may not be present.

If the file is present in block 408, the file may be compared to the previous version. If there are no changes between the current version and the previous versions, the current version may be ignored in block 416. By ignoring the current version in block 416, the current version may be excluded from the subset of versions.

The comparison performed in block 414 may evaluate any changes between the current version and a previous version. In some embodiments, a bit wise comparison may be used to identify changes as small as a single bit. In other embodiments, a hash, check sum, cyclic redundancy check, or other analysis may be performed to identify changes between the versions.

In some versions, a threshold may used to identify a different version. When a certain amount of changes exceeds the threshold, a new version may be identified, otherwise the two versions may be considered identical. The threshold may be defined in many different manners. In one manner, the threshold may be defined as a certain number of bits or bytes that are changed between two versions. In another manner, a percentage change may define a threshold.

If a change is detected in block 414, the changed version maybe added to the subset in block 418. After evaluating each backup instance in block 404, the subset may be defined in block 420 for processing and display.

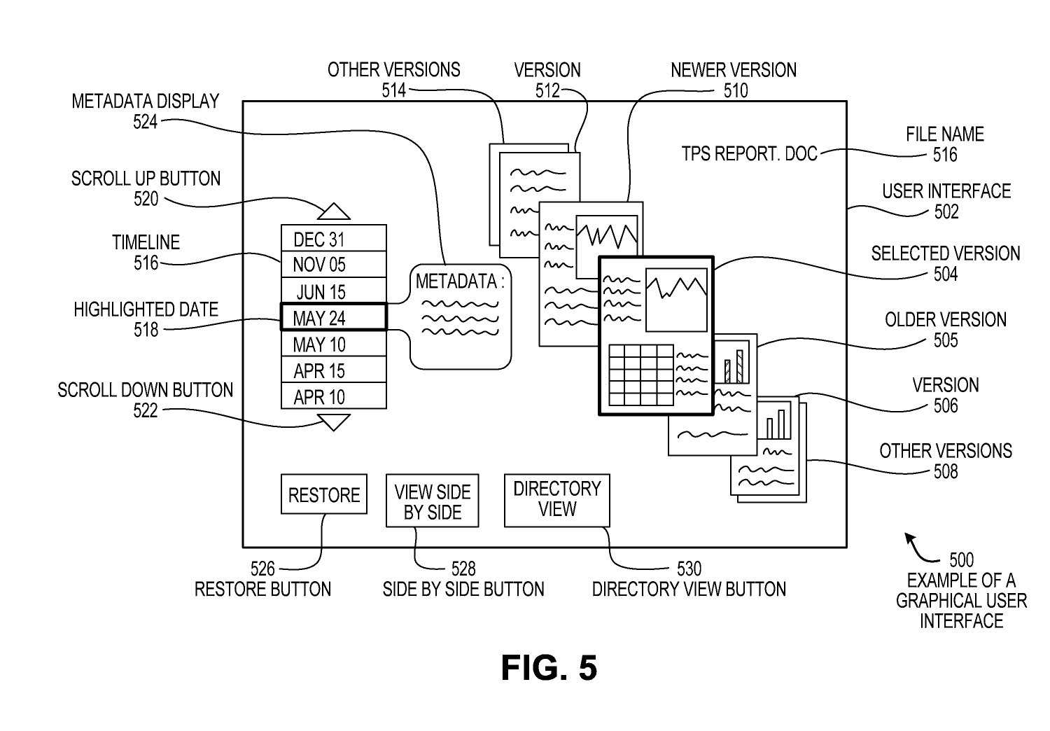

FIG. 5 is a diagram illustration of an embodiment 500 showing a graphical user interface for browsing and selecting a version of a file for restoring. Embodiment 500 is merely one example of an interactive user interface and is used to illustrate how a graphical user interface may look and operate. Other examples include embodiments 600 and 700 illustrated later in this specification.

The embodiments 500, 600, and 700 are selected to show several different features that may be included in a graphical user interface, and various ways versions of a file may be presented, along with various configurations of a timeline. Each of the three embodiments are not intended to coordinate with each other but merely to show different ways certain items may be implemented.

The user interfaces of embodiments 500, 600, and 700 may be presented in windows of a device that can present a graphical user interface. A window may use a portion of a display and may be operable while other applications operate in separate windows. In some embodiments, the user interface may be the only application or function operable on a device and may take up the entire display area of a device.

Embodiment 500 is an example of a graphical user interface 502 that shows a series of versions of a file in a partially overlapping manner. A selected version 504 may be in the center and may be displayed larger than other versions. Older versions 504, 506, and 508 may be included, along with newer versions 510, 512, and 514.

The various versions of the file may be illustrated with graphical representations of the files. In the example of embodiment 500, the file name 516 of “tpsreports.doc” is illustrated as a word processing document. In each representation of the version, a graphical illustration may show the file as the file may be laid out. A user may be able to scan the file to identify which elements have been added or deleted between versions, and the user may select a version based on the visual representation.

In some embodiments, a file viewer application may be used to generate an image of the file and allow a user to pan, zoom, scroll, or otherwise move through the file itself. In some embodiments, such operations may be able to be performed within the graphical user interface 502, while in other embodiments, the viewer application may be launched in a separate window.

The arrangement of the various versions may allow a user to scroll through the versions using a click and drag or swiping motion of the various versions. In some embodiments, a user may be able to point to one version, such as version 506, and cause that version to be the selected version. Some embodiments may have navigation buttons or respond to keyboard commands to navigate through the various versions.

A timeline 516 may be presented in coordination with the versions displayed graphically. The timeline 516 may contain entries with dates that correspond to the changed versions. In embodiment 500, the highlighted data 518 may correspond with the highlighted or selected version 504.

The timeline 516 may have scrolling buttons 520 and 522 that may allow a user to scroll further up or down the timeline to browse different versions.

The timeline 516 may have a metadata display 524 that may be a popup window that shows various metadata for the currently selected version. The metadata may include information like the author of the file, the precise date and time the file was saved, any tags or keywords, file size, or other information.

The embodiment 500 may have a restore button 526. The restore button 526 may cause the selected version 504 to be restored to a local file system from the backup system.

Button 528 may cause the positioning of the files to be a side by side representation. An example of a side by side representation may be found in embodiment 600, and may show two or more versions of a file next to each other so that a user may carefully see the differences between the files.

A directory view button 530 may cause the view to change to show the directory in which the current file is stored. An example of a directory view may be found in embodiment 700.

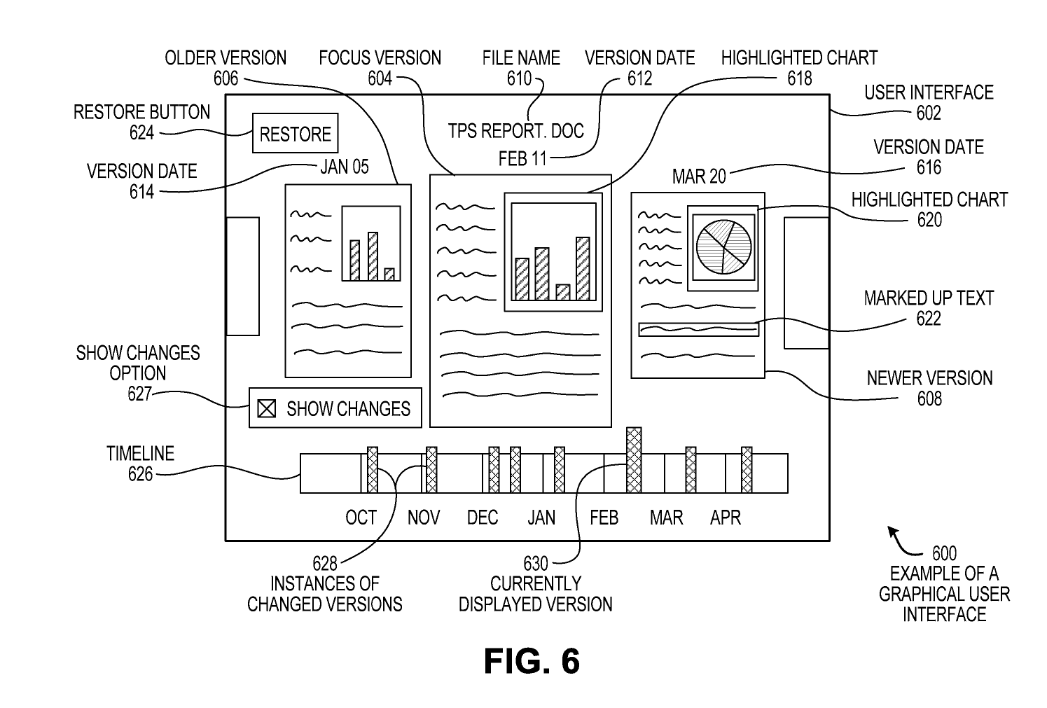

FIG. 6 is a diagram illustration of an embodiment 600 showing a second example of a graphical user interface. Embodiment 600 is merely one example of an interactive graphical user interface and is used as an example of how a graphical user interface may look and operate.

Embodiment 600 presents representations of documents side by side and with highlighting, both of which may help a user identify which version of a document to recover or restore. Some embodiments may employ an analysis routine that may identify specific changes between two versions of a document and highlight those changes using markup techniques, highlighting, or other mechanisms.

The user interface 602 may show three versions of a document. A focus version 604 may be presented in the center, with an older version 606 and a newer version 608 next to the focus version 604. Each version 604, 606, and 608 may have a version date 612, 614, and 616, respectively. The version date may be the date of the backup instance from which the version was found.

The series of version 604, 606, and 608 may be an interactive device that enables a user to scroll through multiple versions. A scrolling action may be initiated by a swiping gesture, navigation buttons, or other user interaction. In many embodiments, a smoothly animated motion may be used to show the series of versions scrolling across the screen.

The user interface may include metadata about the file. Embodiment 600 shows a file name 610 displayed on the user interface. In some embodiments, additional metadata may be displayed along with the file name 610. Some embodiments may display metadata in a window that appears when a cursor or other indicator hovers over a file representation. In one such embodiment, a user can cause a small window to appear with metadata by placing a pointer over one of the three versions for a short period of time, such as a second or two. After the pointer has stayed in one position for a short period of time, a window may appear that contains various metadata, such as keywords, author, time and date of last save, file size, or other metadata.

In some embodiments, a set of commands may be accessed through exercising a cursor selection in a secondary manner. One example of such a manner may be clicking on a mouse device using a secondary button, sometimes known as ‘right-clicking’ when the primary button is the left button on a mouse. The set commands may include recover the selected file, view the selected file in a viewer application, navigate through the file using pan or zoom, or other commands.

The user interface 602 may have a timeline 626. The timeline 626 may have indicators for a period of time as well as indicators 628 for various versions of the file. Each indicator 628 may represent one changed version of the file being displayed. The timeline 626 may have a larger indicator 630 that may represent the current focus version 604.

In many embodiments, the timeline mechanism may be an interactive user interface mechanism. The timeline 626 may be navigated by selecting one of the indicators 628 to change the focus version 604. In some cases, the entire timeline may extend off of the screen on one or both sides. In such cases, a scroll bar, navigation button, or other mechanism may be used to browse or navigate to the portions of the timeline that are not displayed.

The timeline 626 is illustrated as a linear timeline, with even spacing for equal sections of time. In other embodiments, the timeline may vary in spacing to spread out several versions that occur near each other in time, or to collapse long periods of time for which no changed versions exist.

In some embodiments, a backup storage system may keep backup instances with geometrically increasing frequency. For example, a backup system may keep every day's backup for the last two weeks, and every week's backup for several months. After which, backups may be retained on a monthly basis. In such a case, the timeline 626 may show a timeline that is compressed as the timeline grows older, since backup instances are further apart in time. In such cases, the timeline may be compressed using a geometric or exponential function that may show very old versions that are far apart in time as physically close as more recent versions that are close to each other in time.

Embodiment 600 may highlight changes between different versions of a file. For example, the focus version 604 may have the highlighted chart 618. The highlighted chart 618 may be highlighted using outlining, transparent overlays, coloring, or other indicators. The highlighted chart 618 may be the difference between versions 606 and 604. By highlighting the difference, a user may quickly detect the changes, which may help the user to select a desired version.

In another example, the version 608 may have a highlighted chart 620 and marked up text 622. Changed text may be highlighted by illustrating deleted text with a strikethrough, brackets, colored highlighting, or other mechanism, and by illustrating added text using underlining, brackets, different colored highlighting, or other mechanism. Different embodiments may have different ways to highlight or show changes between versions of a file.

Changes to graphical elements, such as photographs, computer generated images, diagrams, or other graphical elements may have graphical and non graphical mechanisms for displaying changes. An example of a graphical mechanism for displaying a cropped image may be to display an older image as partially grayed-out or transparent with the newer image shown in full color. The two images may be superimposed, for example. Some embodiments may show the older image as a thumbnail image or with some other graphical representation. A non graphical representation of a cropped image may present a textual list of changes made to a graphical image. In the example of a cropped image, the edited image may be presented with a list of text descriptions of the changes, such as an entry for “cropping”.

In some embodiments, changes to an image may be highlighted by placing colored transparent overlays on an image. For example, a graphical diagram that has an additional element may be presented with a green transparent box over the newly added element. An element that is modified from one version to another may be presented with a yellow transparent overlay, for example. The precise way graphical images may be presented may vary with the type of image and the software used to create the image.

The embodiment 600 includes a show changes option 627 that may toggle the changes within the representations of the files. The toggle may alternatively highlight the changes or not highlight the changes.

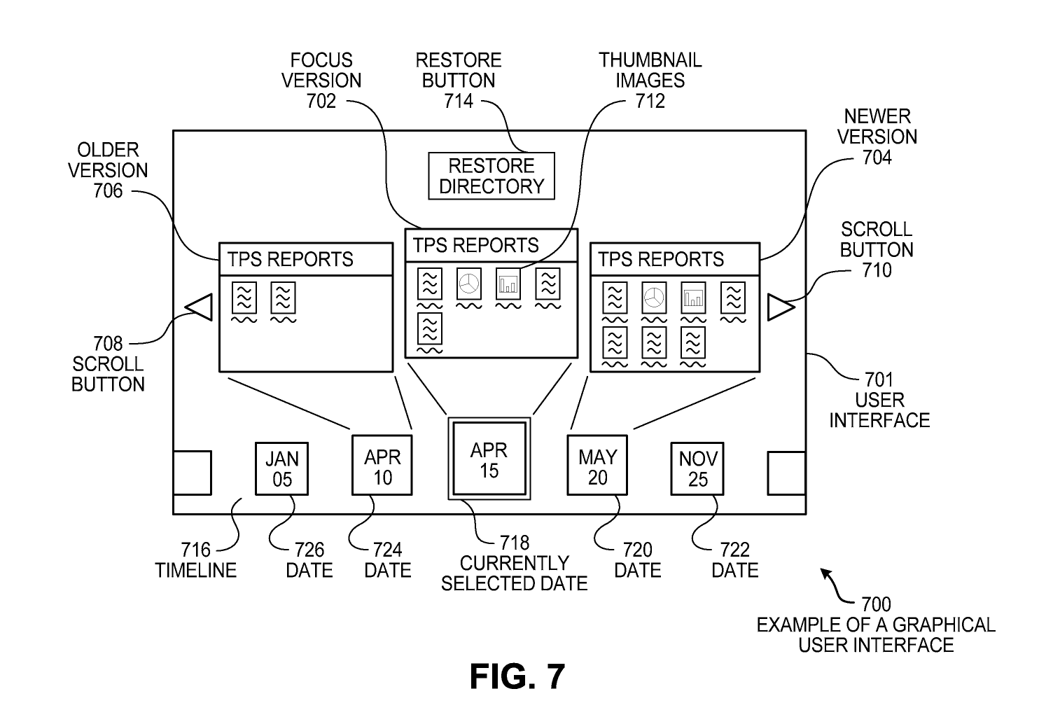

FIG. 7 is a diagram illustration of an embodiment 700 showing an example of a graphical user interface. Embodiment 700 is merely one example of an interactive graphical user interface and is used as an example of how a graphical user interface may look and operate.

Embodiment 700 illustrates an embodiment that may show versions of files, where the files may be directories. Many embodiments may treat directories within a hierarchical directory structure as files, and may be capable of searching for versions of directories and presenting the search results in a graphical user interface.

The graphical user interface 701 may show different versions of a directory. A focus version 702, an older version 706, and a newer version 708 may be shown next to each other. Each directory may be illustrated with thumbnail images 712 that may illustrate the files stored in the directory. In the older version 706, two thumbnails are shown representing two files. In the focus version 702, five thumbnail images are shown, and in the newer version 704, seven thumbnail versions are shown.

In some embodiments, the thumbnail images may be actual images of the files contained in the directory. Such thumbnails may illustrate the contents or partial contents of the respective files. In other embodiments, icons may be used to represent a file without displaying the actual contents of the file.

The versions 702, 704, and 706 may be browsed or scrolled using navigation buttons such as the scroll buttons 708 and 710.

A timeline 716 may operate in a similar fashion as the timelines of embodiments 500 and 600 and allow a user to scroll through or browse the versions of the directory associated with the blocks in the timeline. In contrast to the timeline of embodiment 600 where versions were mapped to a constant timeline, the timeline 716 may arrange blocks representing each date. The date 718 may represent the currently selected or highlighted directory. Date 724 may represent the older version 706, and data 720 may represent the newer version 704. The other dates 726 and 722 may not have a graphical image illustrated, but may be present so that a user may select or scroll to those dates and view the representation of the directory.

Embodiment 700 may have a restore button 714 that may cause a directory or a selected file within a directory to be restored to a file system for normal use.

From the three embodiments 500, 600, and 700, several different graphical layouts may be used to present search results. Within each embodiment, a different type of graphical presentation is illustrated, along with different versions of a timeline from which versions may be selected. The examples are meant only to illustrate different embodiments and are not meant to be limiting in any fashion.

The foregoing description of the subject matter has been presented for purposes of illustration and description. It is not intended to be exhaustive or to limit the subject matter to the precise form disclosed, and other modifications and variations may be possible in light of the above teachings. The embodiment was chosen and described in order to best explain the principles of the invention and its practical application to thereby enable others skilled in the art to best utilize the invention in various embodiments and various modifications as are suited to the particular use contemplated. It is intended that the appended claims be construed to include other alternative embodiments except insofar as limited by the prior art.

What is claimed is:

1. A method being performed on a computer processor, said method comprising:
receiving a file identifier;
searching a backup database for a plurality of versions of a file matching said file identifier, said backup database comprising a plurality of file system backups;
finding said plurality of versions; and
presenting a representation of at least one of said plurality of versions on a graphical user interface.

2. The method of claim 1, said file identifier being a file name.

3. The method of claim 1 further comprising:
analyzing said plurality of versions to identify a subset of said plurality of versions, each of said plurality of versions in said subset being different from another of said plurality of versions in said subset.

4. The method of claim 3 further comprising:
presenting at least two of said plurality of versions from said subset.

5. The method of claim 3 further comprising:
presenting a graphical timeline comprising indicators indicating when a change was made to said file.

6. The method of claim 1, said file identifier being a directory identifier.

7. The method of claim 6, said representation comprising representation of files within a file directory.

8. The method of claim 1 further comprising:
presenting a representation of at least two of said plurality of versions on said graphical interface.

9. The method of claim 8, said representation comprising said at least two of said plurality of versions in a horizontal arrangement.

10. The method of claim 8, said representation comprising at least one highlighted change between said at least two of said plurality of versions.

11. A system comprising:
a backup database configured to store a plurality of versions of files stored in a file system;
a graphical user interface;
a search system configured to retrieve a plurality of versions of a file from said backup database; and
a display system configured to generate a graphical representation of at least two of said plurality of versions of said file and display said graphical representation on said graphical user interface.

12. The system of claim 11 further comprising:
a user input system configured to receive input from a user, said input identifying a specific version of said file; and
a restoration system configured to restore said specific version of said file from said backup database to a storage device.

13. The system of claim 11 further comprising:
an analysis system configured to identify a subset of said plurality of versions of said file, said subset comprising versions of said file that are different from each other.

14. The system of claim 13, said analysis system further configured to determine a changed portion of each version, said changed portion being determined by comparing said version with a previous version.

15. The system of claim 14, said graphical representation comprising a graphical indicator for said changed portion.

16. The system of claim 11, said display system having an input mechanism configured to receive navigation information and change said graphical representation based on said navigation information.

17. The system of claim 11, said file being a directory file.

18. A user interface displayed on a display device, said user interface comprising:
at first set of at least two graphical representations of backup versions of a file;
a navigation mechanism configured to receive user input and change said first set of at least two graphical representations to a second set of at least two graphical representations of backup versions; and
a user input mechanism configured to receive user input for an indicated backup version and launch a restore mechanism, said restore mechanism configured to restore said indicated backup version to a file system.

19. The user interface of claim 18, said navigation mechanism further configured to animate a transition from said first set to said second set.

20. The user interface of claim 18 further comprising:
a timeline mechanism configured to display time indicators for each of said graphical representations.
